(19) United States
(12) Patent Application Publication
(10) Pub. No.: US 2004/0073435 A1
(43) Pub. Date: Apr. 15, 2004

(54) Method for handling return requested items

(76) Inventor: Walter Rosenbaum, Paris (FR)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/266,752

(22) Filed: Oct. 9, 2002

(51) Int. Cl. G06F 17/60

(52) U.S. Cl. 705/1

(57) ABSTRACT

The present invention comprises a method for handling return requested items. The items are returned from a customer to a provider or seller. The items may be returned due to customer dissatisfaction and/or customer failure to properly compensate provider. To effect return, the provider contacts a postal system which arranges for pick up of the item, evaluates the condition and value of the item, advises the provider of the condition and value, and based on instruction from the provider, either provides item information to an auction house for auctioning (along with subsequent shipment to the auction house highest bidder) or retain of item to manufacturer.

### CROSS REFERENCE TO RELATED APPLICATIONS

The present application is a continuation of International Patent Application Number PCT/DE01/01386, filed Apr. 9, 2001. Priority is further claimed to priority German patent application number DE 10017574.0, filed 10 Apr. 2000. The aforementioned references are incorporated herein by reference

### BACKGROUND OF THE INVENTION

The present invention relates to a method for handling return requested items and in particular when such items were ordered on-line. The purpose for return requested items range from dissatisfaction by the customer to failure by the customer to sufficiently compensate the seller for the items. The items in question are generally sold on-line and delivered by standard parcel services. Such items may be paid for in advance or upon delivery. Return of the items are directed, normally, via the standard parcel services.

The purchase of merchandise, from online-providers, over the internet, is on the rise. Of course it can happen that the delivered merchandise does not meet the expectations of the customer because the items for example: don't have the ordered color; are defective; don't correspond to the expectations during visual inspection; or the ordering process was faulty and the desired items were not delivered. In cases of return requested items or return delivery, as is known in the art, the customer must repack the items (possibly in their original packing) provide reasons for their rejection, provide a new address, and make use of a shipping service. This method is undesired and expensive as it causes high shipping charges to the customer and high warehousing costs to the seller.

### SUMMARY OF THE INVENTION

An advantage to the present method includes reduction in transportation and warehousing of return requested items for both the provider and customer. An additional advantage includes an additional service for attracting customers and possibly generating revenue for a postal system. These and other advantages will become clear from the present invention set out in the claims and specification below.

The invention comprises a method wherein ordering, including electronic ordering, of a shipping service by the online-provider, for the collection of the items from the customer, with all the necessary data of the customer and of the shipment data, such as: delivery number, article description, invoice data, and reference data of the shipment, and forwarding to the online-provider or producer/manufacturer or an internet auction house for the execution of an internet auction sale of items corresponding to the position of interests of the online provider (for example free stock capacity, stock keeping costs, shipping charges, condition of the items), is set out.

The present invention further comprises a method for handling of a return item from a customer, said item obtained from a provider and delivered in a package to said customer, comprising the steps of: picking up said package; affixing identification means to said package; verifying integrity of said item; arranging for further disposition of said item to another customer; and delivering said item to said another customer without said item returning to said provider.

Reasons for an order to the postal or shipping service for the collection of the item from the customer may be based upon customer dissatisfaction, the dissatisfaction reasons being communicated from the customer to the provider and possibly further to the postal service. Alternatively, the order may be triggered by the customer failing to adequately compensate the provider for the item.

In another embodiment of the present invention, an auction house, for disposing the item, may be integrated into the postal service, thereby improving communication therebetween, generating an additional source of revenue and/or business opportunity for the postal service, and the like.

The present inventive method may further comprises steps of contacting the customer before picking, arranging for mutually convenient pick up times, and executing pick up accordingly, thereby avoiding unnecessary pick up attempts and costs therefor.

In further method steps, the shipment which was picked up from the shipping service is verified to determine if the contents correspond to the invoiced contents which were communicated by the online-provider, the verification being performed by weighing the shipment without opening and/or x-raying it. The forwarding of the shipped items occurs only upon compliance with the invoiced data.

In further method steps, it is also advantageous to open the packing material of the shipment picked-up from the customer, at the shipping service, and to verify the condition and functionality of the item. A price valuation occurs for damage of the items or impairment of their functionality. Then the items are re-packed and the initial price is determined with the online-provider for the auction if an auction is scheduled before the internet auction house receives the order.

In still further method steps, it is also advantageous, if the online-provider determines for each kind of article if a return to the producer/manufacturer or an online-provider, or if an auction sale at an internet auction house should take place after the collection of the item from the customer. Accordingly, substantial handling charges can be saved.

In still further method steps, the items are only sent to the respective producer/manufacturer by the shipping service in a further embodiment, if a specified minimum amount of articles are picked up by the customers and intermediately stored.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a schematic process of the method for the distribution of the items picked up by the customer without an internet auction; and

FIG. 2 a schematic process of the method for the distribution of the items picked up by the customer with an internet-auction.

### DETAILED DESCRIPTION OF THE INVENTION

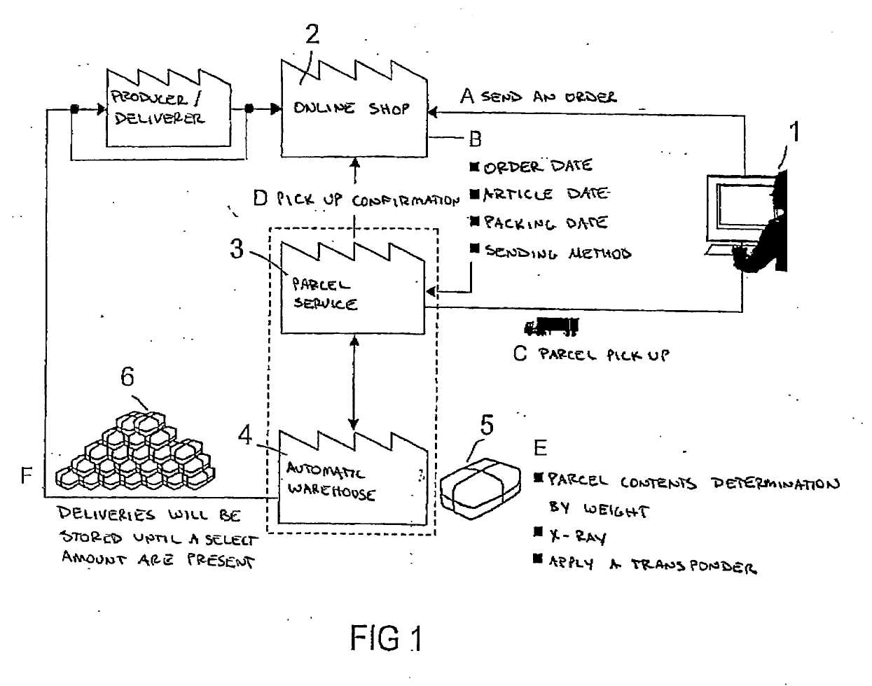

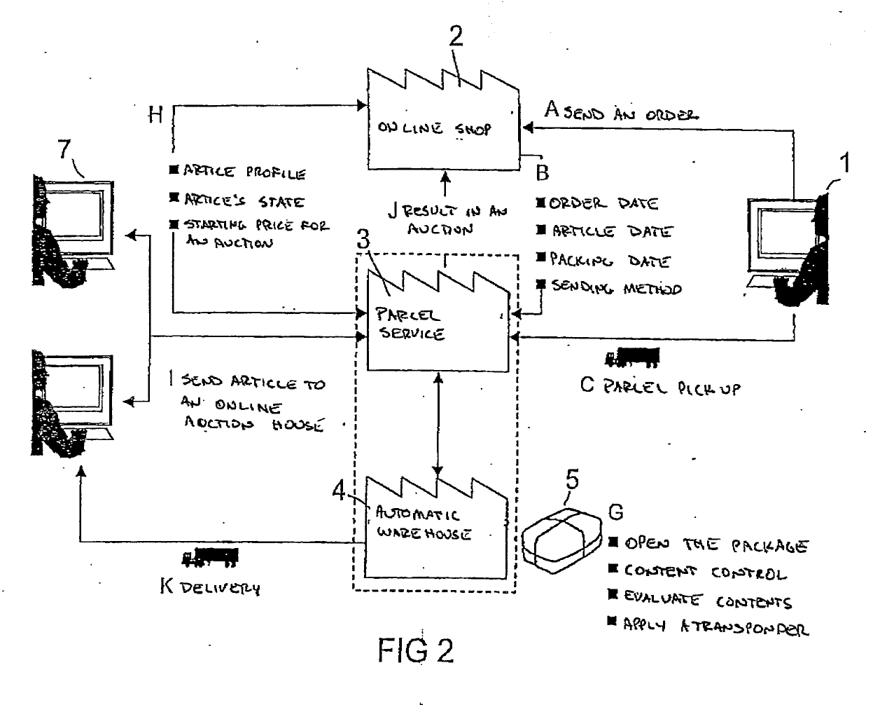

As depicted in FIGS. 1 and 2, an online-provider (mail-order house) 2 stores electronically ordered and delivered items received from an end user, such as customer 1, the items being returned by the customer 1. The reasons for the return could be that the items don't meet the expectations of the customer (wrong color, functionality), the wrong item was delivered, transportation damages, faults or other defects are present, etc. In this case, customer 1 sends an order, e.g. electronic order, to the online-provider 2 for the collection of the delivered items. Then, the online-provider 2 transmits an electronic order B for the collection of the rejected delivered items from the customer 1, the order including: customer data (name, address); and the shipment data such as shipment number, description of the article with indication of size and weight, billing data, and reference data of the shipment 5; to a postal or shipping service 3, in this case a select post office. The order for the collection of the delivered items B is also sent from the online-provider 2 to the shipping service 3 if the customer 1 has not or not fully paid for the article by the due date.

The transmitted data is stored in a database at and by the shipping service 3. Before the collection of the shipment is undertaken, a practical coordination of the collection date and time between the shipping service 3 and the customer 1 occurs so as to avoid additional and unnecessary pick-up attempts. The shipment 5 in the shipping service 3 is stored after collection in an automatic warehouse 4 which belongs to the shipping service 3, as outlined by the dashed line. To create a simple and secure further distribution process, a transponder is installed on the shipment as an identification marker. This transponder can for example contain the shipment number, previous identification data or a new identification which is then filed into the data set. The advantage of a transponder is that no optical reading process has to be carried out for the identification during the distribution. This can of course take place without a transponder, but then the address of the customer or other identification data has to be read from the shipment 5, the date being represented by a bar code and the like. A determination of the content 4 of the shipment 5 occurs before or after the storing or a verification of the condition G of the item by opening the packing material as well as the electronic transmission of a confirmation of collection D to the online-provider 2.

It depends on the pick-up order A and the procedures derived from same within the scope of the order B to the shipping service (3) what is carried out. If the pick-up order A was triggered by customer 1, for example because he received the wrong article or because the commodity's characteristics don't fit the perceived description, a verification of content is generally sufficient without opening the shipment 5, for example by weighing or by x-raying, i.e. it is determined if the shipment content is in compliance with the invoiced value. If this is the case (as disclosed in FIG. 1), then the received shipment to the producer/manufacturer or the online-provider 2 should be forwarded according to necessity F based on the present procedures of the online-provider 2. However, this will occur only when a determined minimum amount of items 6 for the addressee are present, be it items of the same or varying articles. This means that the shipments 5 are intermediately stored and a relocation and shipment to the producer/manufacturer, in particular online-provider 2, occurs F when the necessary minimum amount 6 is present. If a non-match with the invoiced data has been registered during the determination of the content without opening the packing material of the shipment (5), then the delivery (5) is opened and the results are communicated to the online-provider (2) who then decides if a forwarding as scheduled or if an auction in an internet-auction house should occur.

The method steps disclosed in FIG. 2 disclose the case of an issuing of an auction decree by the online-provider 2 based on the transportation, storage, and cost situation. The first steps proceed as disclosed in FIG. 1, i.e. the online-provider 2 sends an electronic order B to the shipping service 3 for the collection of the rejected items delivered to the customer after the pick-up order A of the customer 1. This order also contains the customer's data (name, address) and the shipment data, such as: shipment number, description of the article with indication of size and weir, billing data, and identification data of the shipment. The shipment 5 is then intermediately stored in the warehouse 4 of the shipping service 3 after the collection of the rejected articles. Should the items be auctioned based on the procedures set out in the order B, then the shipment 5 is opened before the intermediate storage in the warehouse 4 and a verification of content occurs, i.e. the items are checked regarding their condition and if necessary their functionality and a valuation occurs if required. The opening of the shipment and the verification of the condition and/or integrity of the items also occur if the verification of the content of the shipment without opening the packing material has shown that a difference from the invoiced value is present. Should the item(s) be auctioned based on the order B of the online-provider 2, without claiming their condition or functionality by the customer 1, the procedures also contains the initial price for the auction. If the condition of the item is imperfect (result of the content's verification), then a valuation occurs and the condition and the assessed value are then sent to the online-provider 2, who, following this, transmits the modified initial price to the shipping service 3. Afterwards, the shipping service electronically sends an auctioning order I with the initial price and the information about the items (technic data, picture) to an internet auction house which then carries out the auction. Modified data with the help of the transmitted data is then printed (for example a new invoice) for the accepted auction bidder 7, the shipment is withdrawn from the storage according to the stored data in the database, and the corresponding identifications of the shipment 5 (advantageously a coded transponder) made ready for shipment to the new receiver and is delivered to him K. Simultaneously, the result from the auction is sent to the online-provider 2 J. If the items could not be sold at the auction, their whereabouts are coordinated with the online-provider 2.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. A method for handling of a return item from a customer, said item obtained from a provider and delivered in a package to said customer, comprising the steps of:
picking up said package from said customer;
affixing identification means to said package;
verifying integrity of said item;
arranging for further disposition of said item to another customer; and
delivering said item to said another customer without said item returning to said provider.

2. The method according to claim 1, wherein said steps of picking, affixing, verifying, arranging, and delivering are performed by a postal service.

3. The method according to claim 2, wherein said step of picking up further comprises the steps of said postal service contacting said customer, prior to picking up said package, and arranging for a mutually convenience pick up time and place.

4. The method according to claim 1, wherein said identification means comprises a transponder.

5. The method according to claim 1, wherein said identification means comprises a bar code.

6. The method according to claim 1, wherein said step of verifying integrity is performed without opening said package.

7. The method according to claim 6, wherein said step of verifying further comprises the step of exposing said package to radiation whose detection from said package provides sufficient information to verify integrity of contents of said package.

8. The method according to claim 7, wherein said radiation are x-rays.

9. The method according to claim 1, wherein said step of verifying integrity is performed by opening said package and inspecting contents thereof.

10. The method according to claim 2, further comprising the step of valuating said item.

11. The method according to claim 10, wherein said step of arranging for further disposal further comprises the steps of:
indicating value of said item, based on said valuating, to said provider;
deciding, at said provider, whether said value warrants return of the item to its manufacture or conveying said item to an auction house with said value; and
if said item is conveyed to said auction house, instructing said postal service to performing conveying.

12. The method according to claim 11, wherein said postal service conveys said items to said auction house only after a predetermined number of conveying orders have been received and wherein said another customer is a highest bidder at said auction house.

13. The method according to claim 12, wherein said auction house comprises an online auction house.

14. The method according to claim 2, further comprising the steps of generating an order by said provider to said postal service to pick up said item and package.

15. The method according to claim 14, wherein said order is an electronic order and initiated by customer dissatisfaction with said item.

16. The method according to claim 14, wherein said order is an electronic order and initiated by customer failure to properly compensate said provider for said item.

17. The method according to claim 13, wherein said postal service comprises said auction house.

18. The method according to claim 6, wherein said step of verifying integrity is performed by weighing said package.
